(19) United States
(12) Patent Application Publication
(10) Pub. No.: US 2026/0219945 A1
(43) Pub. Date: Jul. 30, 2026

(54) INFORMATION HANDLING SYSTEM WITH LOCAL MODEL RESOURCE ALLOCATION

(71) Applicant: DELL PRODUCTS L.P., Round Rock, TX (US)

(72) Inventors: Jacob Mink, Cedar Park, TX (US); Spencer Bull, Conroe, TX (US); Tyler Cox, Austin, TX (US); Nicholas Wanner, Austin, TX (US); Srikanth Kondapi, Austin, TX (US)

(21) Appl. No.: 19/036,766

(22) Filed: Jan. 24, 2025

(51) Int. Cl. G06F 9/50; G06F 9/48

(52) U.S. Cl. CPC G06F 9/5033; G06F 9/4881; G06F 2209/501

(57) ABSTRACT

An information handling system stores a multiple machine learning (ML) models. The system receives a job request that includes input parameters and constraints for a job associated with the job request. Based on the input parameters and the constraints, the system identifies first and second ML models available to execute the job. The system also generates a first score for the first ML model and a second score for the second ML model. Based on the first score being greater than the second score, the system provides the job to a compute resource associated with the first ML model.

### FIELD OF THE DISCLOSURE

The present disclosure generally relates to information handling systems, and more particularly relates to allocating local model resources within an information handling system.

### BACKGROUND

As the value and use of information continues to increase, individuals and businesses seek additional ways to process and store information. One option is an information handling system. An information handling system generally processes, compiles, stores, or communicates information or data for business, personal, or other purposes. Technology and information handling needs and requirements can vary between different applications. Thus, information handling systems can also vary regarding what information is handled, how the information is handled, how much information is processed, stored, or communicated, and how quickly and efficiently the information can be processed, stored, or communicated. The variations in information handling systems allow information handling systems to be general or configured for a specific user or specific use such as financial transaction processing, airline reservations, enterprise data storage, or global communications. In addition, information handling systems can include a variety of hardware and software resources that can be configured to process, store, and communicate information and can include one or more computer systems, graphics interface systems, data storage systems, networking systems, and mobile communication systems. Information handling systems can also implement various virtualized architectures. Data and voice communications among information handling systems may be via networks that are wired, wireless, or some combination.

### SUMMARY

An information handling system may store a multiple machine learning (ML) models. The system may receive a job request that includes input parameters and constraints for a job associated with the job request. Based on the input parameters and the constraints, the system may identify first and second ML models available to execute the job. The system also may generate a first score for the first ML model and a second score for the second ML model. Based on the first score being greater than the second score, the system may provide the job to a compute resource associated with the first ML model.

In another embodiment, the system may receive a first job request from a first application. The first job request includes first quality of service (QoS) requirements for a first job of the first application. The information handling system may determine a first ML model to execute the first job. The information handling system may also receive a second job request from a second application. The second job request includes second QoS requirements for a second job of the second application. The information handling system may determine a second ML model to execute the second job. The information handling system may also determine a conflict between the first QoS requirements and the second QoS requirements. Based on the conflict, the information handling system may allocate resources between the first ML model and the second ML model based on priority levels of the first and second applications

### BRIEF DESCRIPTION OF THE DRAWINGS

It will be appreciated that for simplicity and clarity of illustration, elements illustrated in the Figures are not necessarily drawn to scale. For example, the dimensions of some elements may be exaggerated relative to other elements. Embodiments incorporating teachings of the present disclosure are shown and described with respect to the drawings herein, in which:

FIG. 1 is a block diagram of portion of an information handling system according to at least one embodiment of the present disclosure;

FIG. 2 is a sequence diagram to select a machine learning (ML) model and corresponding local resource within an information handling system according to at least one embodiment of the present disclosure;

FIG. 3 is a flow diagram of a method for selecting ML models for multiple applications that are concurrently executed within an information handling system according to at least one embodiment of the present disclosure;

FIG. 4 is a flow diagram of a method for selecting an ML model and corresponding local resource within an information handling system according to at least one embodiment of the present disclosure;

FIG. 5 is a flow diagram of a method for assigning an ML model to local or external resources according to at least one embodiment of the present disclosure; and

FIG. 6 is a block diagram of a general information handling system according to an embodiment of the present disclosure.

The use of the same reference symbols in different drawings indicates similar or identical items.

### DETAILED DESCRIPTION OF THE DRAWINGS

The following description in combination with the Figures is provided to assist in understanding the teaching disclosed herein. The description is focused on specific implementations and embodiments of the teaching and is provided to assist in describing the teachings. This focus should not be interpreted as a limitation on the scope or applicability of the teachings.

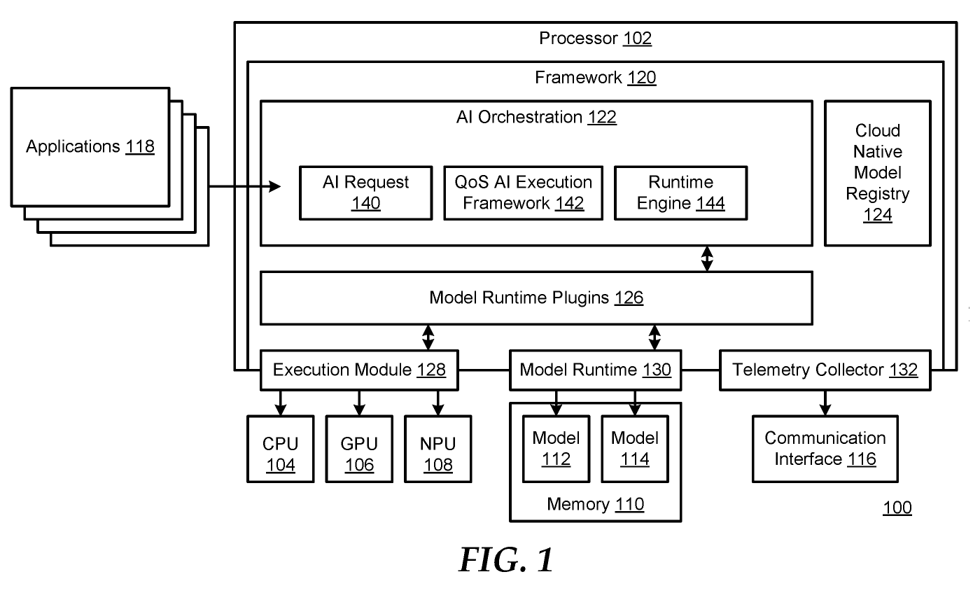

FIG. 1 illustrates a portion of an information handling system 100 according to at least one embodiment of the present disclosure. For purposes of this disclosure, an information handling system can include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, an information handling system may be a personal computer (such as a desktop or laptop), tablet computer, mobile device (such as a personal digital assistant (PDA) or smart phone), server (such as a blade server or rack server), a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, touchscreen and/or a video display. The information handling system may also include one or more buses operable to transmit communications between the various hardware components.

Information handling system 100 includes a processor 102, a central processing unit (CPU) 104, a graphics processing unit (GPU) 106, and a neural processing unit (NPU) 108, and a memory 110. Memory 110 may store machine learning (ML) models 112 and 114 and other data associated with the execution of the ML models. While only two ML models 112 and 114 are illustrated in FIG. 1, information handling system may include any suitable number of ML models. Information handling system 100 further includes a communication interface 116 and different applications 118 may be executed within the information handling system 100. Processor 102 includes a framework 120, which in turn includes an artificial intelligence (AI) orchestration module 122, a cloud native model registry 124, model runtime plugins 126, an execution module 128, a model runtime module 130, and a telemetry collector 132. In an example, framework 120 may be any suitable framework, such as a model management framework (MMF), a client model runtime framework, or the like. AI orchestration module 122 includes an AI request module 140, a quality of service (QoS) execution framework 142, and a runtime engine 144. Information handling system 100 may include additional components without varying from the scope of this disclosure. For example, information handling system 100 may also include an integrated GPU (iGPU), a dedicated or discrete GPU (dGPU), an integrated NPU (iNPU), a dedicated or discrete NPU (dNPU), or the like.

During operation of information handling system 100, telemetry module 122 may monitor and collection data associated with processor 102, CPU 104, GPU 106, and NPU 108. For example, telemetry module 122 may collect device metrics for processor 102, CPU 104, GPU 106, and NPU 108. Telemetry module 122 may provide the collected metrics and other data to other information handling systems, such as cloud servers, via communication interface 116. Applications 118 may utilize AI request module 140 to communicate with AI orchestration 122 and framework 120, such that the applications may provide application programming interface (API) request to processor 102.

Applications 118 may be line of business (LOB) applications that include artificial intelligence (AI) applications, such as conversational AI applications, video conferencing applications, photography editing applications, or the like. In certain examples, framework 120 model runtime plugins 126, execution module 128, and model runtime module 130 may facilitate the consumption of AI device-enabled AI capabilities within LOB applications 118. In an enterprise environment, an information technology administrator typically deploys LOB applications to a fleet of client devices using remote management solutions. However, tracking and/or coordinating the complex and increasing number of dependencies of applications on framework 120 in a diverse AI computing ecosystem is increasingly becoming difficult.

In an example, QoS AI execution framework runtime engine 144 may execution module 128 and utilize ML model runtime module 130 to execute trained ML models 112 and 114. Within execution module 128 and ML model runtime module 130, CPU 104, GPU 106, and NPU 118 may receive data from applications 118, perform one or more hidden operations of ML models 112 and 114, and provide outputs to the applications. ML model runtime module 130 may be optimized for speed and scalability to handle real-time API requests from applications 118. For example, ML model runtime modules 160 and 162 may receive API requests, route the requests to the appropriate resource and ML model, and return the output of the ML model. In an example, the appropriate resource may be selected from CPU 104, GPU 104, and GPU 106. And the ML model may be selected from ML model 112 and 114.

During operation of information handling system 100, multiple AI-driven applications 118 may be run or executed at the same time. In an example, each of application 118 may have different and distinct quality of service (QoS) requirements for jobs to be performed by a compute resource, such as CPU 104, GPU 104, and GPU 106, of information handling system 100. For example, a video conferencing application may include a high accuracy QoS for speech-to-text transcription with a low latency QoS to maintain conversational flow. Alternatively, a photography editing application may utilize AI-based filters with medium accuracy QoS but prioritizes fast execution QoS for seamless editing. At the same time, a language processing application might summarize documents, which may cause prioritizing a high throughput QoS over an accuracy QoS to handle large datasets efficiently.

Based on the QoS requirements, each application 118 may provide a job request that defines a QoS contract specifying a required accuracy, latency, and resource preferences for the associated job. In certain examples, these QoS contracts may also specify application-level accuracy constraints for a ML model executing the job of the job request. The QoS contracts may also include, but are not limited to, accuracy targets, latency thresholds, performance metrics, power constraints, resource allocation priorities, minimum and maximum resource usage thresholds, fallback policies, information technology (IT) policy overrides, or the like.

In certain examples, QoS constraint for an accuracy target may include a precision target for an ML model inference, such as exact precision, high precision, medium precision , low precision, or the like. The latency threshold QoS constraint may include a maximum duration for the execution of a ML model, such as milliseconds for real-time applications. In an example, the performance metrics QoS constraint may include throughput requirements, such as tokens/second, frames/second, inferences per second, or the like. The power QoS constraint may include upper limits for energy consumption during execution of the ML model.

The resource allocation priorities QoS constraint may include compute resource preferences, such as prioritize GPU 106 over CPU 104, or the like. In an example, the minimum and maximum resource usage thresholds QoS constraint may include CPU 104 utilization limits, memory utilization limits, or the like. The fallback policies QoS constraint may define acceptable alternatives if accuracy targets cannot be met, such as switching to lower-accuracy ML models, degrade gracefully, or the like. The IT policy overrides QoS constraint may include enterprise policy overrides for QoS parameters. In certain examples, these QoS constraints or contracts may have a high level of granularity, such that the QoS contracts define accuracy, latency, resource preferences, and fallback policies at the application level.

In an example, processor 102 may dynamically allocate compute resources, such as CPU 104, GPU 104, and GPU 106, to satisfy these QoS contracts. Processor 102 may also adapt ML model selection, quantization, and runtime configurations based on the constraints in the QoS contracts. Additionally, processor 102 may resolve conflicts between competing applications 118 to ensure no QoS agreement is breached, even under system constraints such as high utilization or low power, as will be described below.

In certain examples, processor 102, via AI request module 140, may receive a job request from one of applications 118. In response to the job request, extract details or data associated with the job identified in the job request. The data may include a QoS contract for the execution of the job by a ML model and corresponding compute resource of information handling system 100. Processor 102 may utilize the QoS contract to dynamically select ML model 112 or 114 to execute the job within the job request. In an example, processor 102 may determine the accuracy target QoS requested for the job. Based on the determined accuracy target QoS, processor 102 may match the accuracy target for the requesting application 118 to an appropriate ML model, such as ML model 112 or 114. In an example, ML models 112 and 114 may be pre-trained ML models, fine-tuned ML model versions, or the like.

Prior to the model selection process, multiple quantization and/or conversion techniques may be created for ML models 112 and 114. In an example, the quantization and/or conversion of the ML models may be into any suitable technology, such as ONNX or any other intermediate representations. These quantizations and/or conversions may include different mixtures of characteristics, such as ONNX CPU float32, ONNX CPU float16, ONNX CPU int4, ONNX GPU float16, or the like.

During the model selection process, processor 102 may perform other suitable operations to determine the best ML model 112 or 114. For example, processor 102 may select one of the quantization and/or conversion techniques for the ML model. In an example, the selection of the quantization and/or conversion technique may be based on the technique that may optimize execution while satisfying accuracy and latency QoS constraints for the requesting application 118. In certain examples, processor 102 may dynamically adapt the ML model selection process, such that the processor may select and configure ML models in real-time and select the quantization or conversion as needed.

Processor 102 may maintain a library of ML models with metadata in memory 110, such that the processor may utilize the metadata to perform efficient decision making of selection between ML models 112 and 114. In an example, this metadata may include performance metrics of ML models 112 and 114 under different configurations. Based on the accuracy QoS and other QoS constraints, processor 102 may select any suitable compute resource and ML model to execute the job from requesting application 118. For example, processor 102 may determine that GPU 106 and ML model 112 may perform the desired operations while maintaining the requested accuracy and other QoS requirements received from requesting application 118. Processor 102 may then assign the job to GPU 106 and ML model 112.

In certain examples, processor 102, via AI request module 140, may receive another job request from a different one of applications 118. In response to this job request, processor 102 may perform the operations described above to select and assign a ML model and compute resource, such as ML model 114 and NPU 108, to the corresponding job. Additionally, processor 102 may determine whether any conflicts exist between competing QoS contracts of the jobs from different applications 118. If conflicts exist, processor 102 may perform any suitable operations to resolve these conflicts while maintaining the QoS agreements for each application 118.

In an example, processor 102 may dynamically and continually perform conflict detection and resolution associated with application QoS contracts. For example, processor 102 may perform conflict detection and resolution when a new job is requested from one of applications 118, while two or more ML models are being executed, or the like. During a conflict detection process, processor 102 may monitor both the QoS contracts and the resource demands associated with different jobs requested by application 118. In an example, processor 102 may identify or determine when resource demands or accuracy requirements overlap across applications 118.

In response to conflict detection, processor 102 may perform one or more operations to resolve the conflict. For example, processor 102 may perform priority-based resolution, dynamic accuracy adjustment, implement fairness policies, or the like. In certain examples, processor 102 may perform the conflict resolution by only one of the conflict resolution techniques or may perform any combinations of these conflict resolution techniques.

If processor 102 performs priority-based resolution, the processor may determine different priority levels for applications 118. For example, processor 102 may assign priority levels to the different applications based on any suitable criteria, such as accuracy requirements, latency requirements, or the like. In an example, processor 102 may assign a higher priority level to applications that are real-time applications, such as video conferencing applications, as compared to other nonreal-time applications, such as batch processing applications. In this example, processor 102 may allocate resources, such as compute devices and memory, to the higher priority real-time applications over nonreal-time applications.

In certain examples, processor 102 may utilize dynamic accuracy adjustments to resolve conflicts between applications 118. For example, processor 102 may analyze the accuracy target QoS constraints for applications 118 that are in conflict and assign priority levels based on the accuracy targets of the applications. Processor 102 may assign higher priority levels to applications that have higher accuracy targets or requirements as compared to applications with lower accuracy targets or requirements. In this situation, processor 102 may reduce the accuracy targets for lower QoS applications 118 so that the accuracy targets for critical QoS contracts may be maintained or preserved.

In an example, processor 102 may utilize fairness policies to resolve conflicts between applications 118. For example, processor 102 may analyze assigned priority levels of different applications 118 and determine whether two or more applications have similar priority targets. If processor 102 determines that two or more applications 118 have the same priority targets, the processor may enable or assign equal resource distribution between these applications. In certain examples, processor 102 may determine different groups or sets of applications that have similar priority targets, such that one set of applications have one priority target and a different set of applications have a different priority target. In this situation, processor 102 may assign equal resource distribution between the applications of the first set of applications and equal resource distribution between the application of the second set of applications. However, the resource distribution between the two sets of applications may not be equal. As described herein, processor 102 may utilize multiple application conflict resolution to balance competing accuracy QoS and resource demands across applications 118.

In certain examples, processor 102 may perform one or more other operations to maintain QoS compliance of applications 118 being executed by ML models 112 and 114 and the corresponding compute resources, such as CPU 104, GPU 106, and NPU 108. For example, processor 102 may execute or perform runtime resource management during the execution of applications 118. During runtime resource management, processor 102 may continuously monitor the system state of information handling system 100 and update the configurations of ML models 112 and 114 to maintain QoS compliance of applications 118.

In an example, processor 102 may monitor a current resource utilization level, active tasks, power and thermal states, or the like. The current resource utilization level monitored for any component of information handling system 100, such as CPU 104, GPU 106, and NPU 108, and a memory. Processor 102 may also monitor active background and foreground tasks along with power and thermal states within information handling system 100.

Based on any one or more of these monitored components, processor 102 may adjust different configurations of ML models 112 and 114 to maintain QoS compliance for applications 118. For example, processor 118 may dynamically adjust runtime configurations of ML models 112 and 114 to maintain QoS compliance for applications 118. Additionally, processor 102 may modify batch sizes or streaming configurations of ML models 112 and 114 to maintain QoS compliance for applications 118. Processor 102 also may switch between compute devices based on real-time availability to maintain QoS compliance for applications 118. For example, processor 102 may switch the execution of ML model 112 from GPU 106 to CPU 104 to maintain QoS compliance for applications 118.

During execution of jobs from applications 118 via ML models 112 and 114, processor 102 may perform a real-time feedback loop to continually learn and adapt to changing QoS application contracts on information handling system 100. In an example, processor 102 may perform real-time monitoring of the actual performance of selected ML models 112 and 114 against QoS contracts for applications 118. For example, the actual performance of ML models 112 and 114 may be the observed accuracy, latency, and resource impacts of the ML models when executing applications 118. Based on these performance levels, processor 102 may adapt future model selection decisions for applications 118 with similar QoS contracts. Also, processor 102 may continuously refine application-level QoS contracts based on learned personalization of user behavior of information handling system 100. Thus, processor 102 may adapt to user behavior over time, ensuring sustained optimization of user experience while maintaining of ML models accuracy and other QoS contracts.

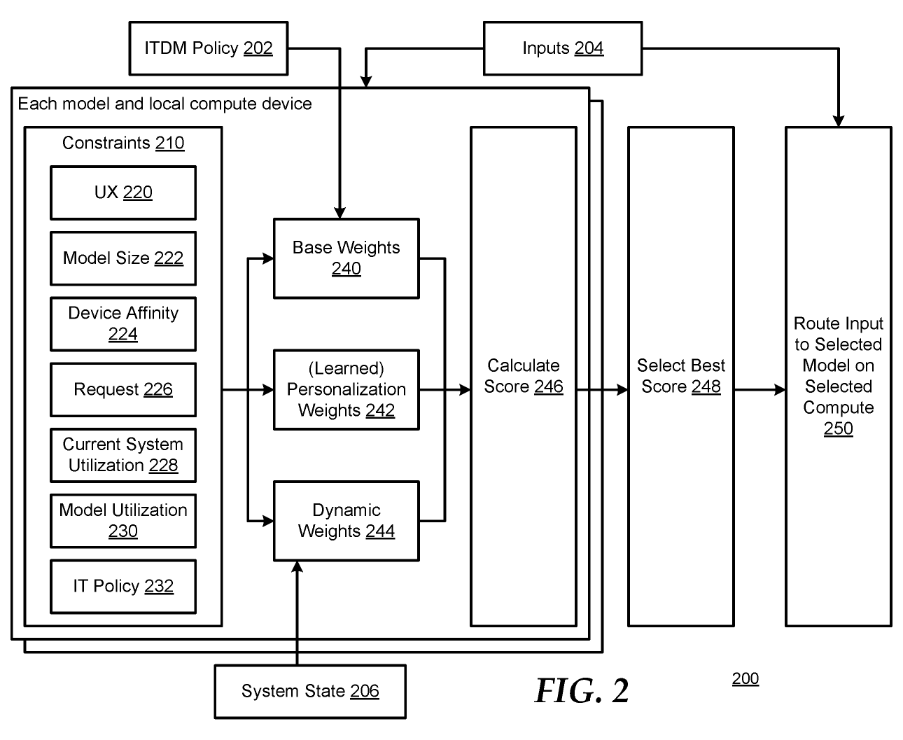

FIG. 2 illustrates a sequence of operations 200 to select a ML model and a compute resource to execute the ML model according to at least one embodiment of the present disclosure. Sequence of operations 200 may be performed by components of an information handling system, such as the components of information handling system 100 in FIG. 1. For example, any combination of processor 102, CPU 104, GPU 106, NPU 108, and memory 110 of information handling system 100 may perform, or be utilized during, the operations described with respect to FIG. 2.

In an example a processor, such as processor 102 of FIG. 1, may receive data from multiple sources and utilize this data to select a ML model and corresponding compute resource. For example, the processor may receive an information technology decision maker (ITDM) policy 202, a set of inputs 204, and a system state 206. In an example, an information handling system may include multiple ML models, such as ML models 112 and 114 of FIG. 1, and multiple local compute devices, such as CPU 104, GPU 106, NPU 108 of FIG. 1, CPU, an iGPU, a dGPU, an iNPU, and a dNPU, to execute the ML models.

In certain examples, each ML model and local compute device with have QoS constraints 210 to be met during the execution of the ML model. QoS constraints 210 may include, but are not limited to, user experience (UX) 220, model size 222, device affinity 224, request 226, current system utilization 228, model utilization 230, and IT policy 232. In an example, the UX constraint 220 may include, but is not limited to, ML model accuracy, capability/fine-tuning, speed, and blocks/stream. Model size 222 may indicate a QoS constraint of how large the ML model may be for execution. In an example, QoS constraint for device affinity 224 may indicate a particular type of compute resource to execute the ML model. QoS constraint request 226 may be how particular requests should be handled. Current system utilization 228 may be a QoS constraint that the system utilization should be kept under a predetermined level. Similarly, model utilization 230 may be a QoS constraint that the ML model utilization should be kept under a predetermined level. IT policy 232 constraints automated system constraints.

When ML models are executed by compute resources in a local environment, such as in information handling system 100 of FIG. 1, often there may be more than one available physical resource on which to run the model. These physical compute devices may include, but are not limited to, CPU 104, GPU 106, NPU 108 of FIG. 1, CPU, an iGPU, a dGPU, an iNPU, and a dNPU. In certain examples, multiple applications, such as application 118 of FIG. 1, may consume these physical resources. An information handling system, such as information handling system 100 of FIG. 1, may be improved by processor scheduling ML models across these resources while maintaining ML model and system performance QoS requirements, user experience QoS constraints, and physical limitations of the hardware as will be described herein.

In an example an application, such as a productivity application, running on information handling system 100 of FIG. 1 may request a real-time AI-driven assistance. The information handling system may have multiple compute resources available, such as a CPU, an iGPU, and a dGPU, for execution of the application. However, the information handling system may also be running a video conference application that is CPU-heavy and a rendering graphics application that is dGPU-intensive. Based on the request, a processor may execute an automatic AI model scheduling engine to optimally assign AI workloads to available compute within an information handling system. In certain examples, this engine enables the processor to dynamically balance system performance, user experience, and resource constraints by leveraging a weighted scoring mechanism.

In certain examples, the processor may receive inputs 204 from an application. Inputs 204 may include, but is not limited to, a request for a job to be performed by a ML model, QoS constraints for the application, and data to be input to the ML model. In an example, inputs 204 may include the AI request from the application along with input parameters, user constraints 220, and automated system constraints or IT policies 232. Based on inputs 204, the processor may perform any suitable operations to resolve resources and models for the AI request. For example, the processor may identify both locally available ML models and cloud-downloadable ML models. The processor may also compute predicted load times for each of the available ML models in different compute resources based on model size 222.

The processor may combine current system utilization 228 with UX constraint 220, model size 222, device affinity 224, and policy constraints 232 to define execution boundaries for the AI request. In an example, the processor may utilize these constraints and inputs 204 to calculate different weights for each of the available ML models and available compute resources. In certain examples, the processor may calculate a weighted score 246 for each ML model-compute resource pair. For example, the processor may calculate weight score for ML model 112 and CPU 104 of FIG. 1, ML model 112 and GPU 106 of FIG. 1, ML model 112 and NPU 108 of FIG. 1, ML model 114 and CPU 104, ML model 114 and GPU 106 of FIG. 1, and ML model 114 and NPU 108. The weighted scores 246 may be based on base weights 240, learned or personalization weights 242, and dynamic weights 244 for each ML model-compute resource pair.

In an example, the processor may utilize the ML model and compute resource pair constraints 210 and ITDM policy data 202 to set base weight 240 for each ML model and compute resource pair. For example, ITDM policy data 202 may include a default system prioritization for the information handling system, and the processor may utilize the default system prioritization to create a base weight 240 for each ML model and compute resource pair.

In certain examples, the processor may collect and learn patterns from user behavior and preferences. The processor may utilize these learned patterns to calculate personalization weights 242 for constraints 210 of each ML model and compute resource pair. In an example, the processor may determine real-time system state metrics 206 for the information handling system. Based on the real-time system state metrics 206, the processor may calculate or determine dynamic weights 244 for the constraints 210 of each ML model and compute resource pair.

After base weights 240, personalization weights 242, and dynamic weights 244 for each ML model and compute resource pair have been calculated, the processor may calculate a different overall score 246 for each ML model and compute resource pair. In certain examples, the overall score 246 may be a sum of weights 240, 242, and 244, may be an average of the weights, or the like. After the overall scores 246 have been calculated for each of the ML model and compute resource pairs have been calculated, the processor may select the ML model and compute resource pair with the highest or best score 248. Additionally, the processor may identify the ML model and compute resource pair with the second highest score as a fallback ML model and compute resource pair. The processor may route inputs 204 from the application to the selected or highest score ML model and compute resource pair for execution. In an example, if the selected ML model and compute resource pair fails to operate, the processor may provide inputs 204 to the fallback ML model and compute resource pair for execution.

As described herein, the information handling system may resolve and prioritize multiple constraints 210, such as user experience requirements 220, model characteristics 222. IT policies 232, and device affinity 224, to tailor execution of input 204 from an application by the best available ML model and compute resource pair. In this situation, the information handling system may ensure optimal results for the requesting application. Additionally, the information handling system may incorporate a fallback mechanism, such as fallback ML model and compute resource pair, to guarantee uninterrupted service even in cases of resource failure. These operations by the processor of the information handling system may combine real-time adaptation with long-term learning to deliver a scamless and continnually optimized AI workload scheduling experience within the information handling system.

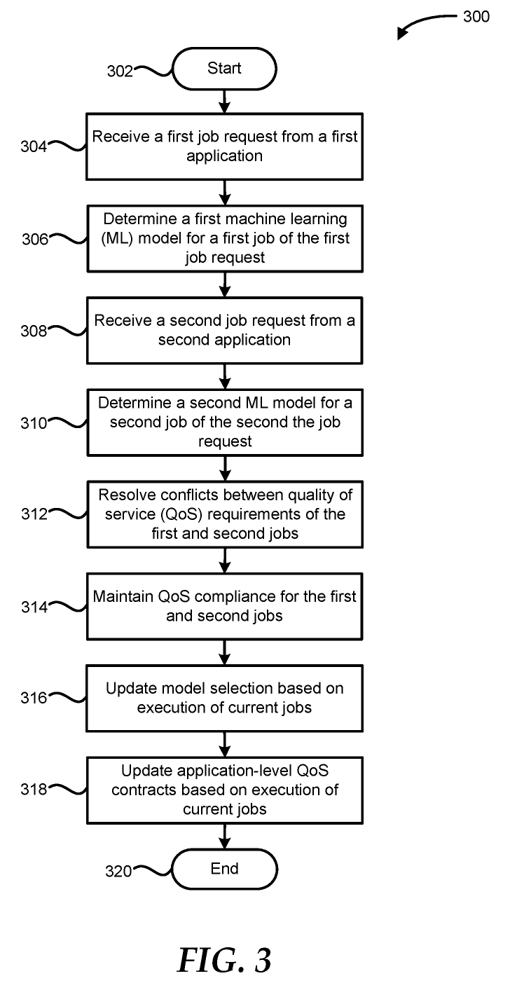

FIG. 3 shows a method 300 for selecting ML models for multiple applications that are concurrently executed within an information handling system according to at least one embodiment of the present disclosure, starting at block 302. Not every method step set forth in this flow diagram is always necessary, and certain steps of the methods may be combined, performed simultaneously, in a different order, or perhaps omitted, without varying from the scope of the disclosure. FIG. 3 may be employed in whole, or in part, processor 102 of information handling system 100 in FIG. 1, or any other type of controller, device, module, processor, or any combination thereof, operable to employ all, or portions of, the method of FIG. 3.

At block 304, a first job request is received from a first application. The first application may be running in an information handling system. The job request may include details or data associated with a first job identified in the job request. The data may include a QoS contract for the execution of the first job by a ML model and corresponding compute resource of information handling system.

At block 306, a first ML model is determined for a first job of the first job request. In an example, the QoS contract for the first application may be utilized to dynamically select the first ML model to execute the job within the job request. In certain examples, a determined accuracy target QoS for the first application may be used to select the first ML model. In an example, the first ML model may be a pre-trained ML model, a fine-tuned ML model version, or the like.

At block 308, a second job request is received from a second application. The second application may be running in an information handling system. The job request may include details or data associated with a second job identified in the job request. The data may include a QoS contract for the execution of the second job by a ML model and corresponding compute resource of information handling system.

At block 310, a second ML model is determined for a second job of the second job request. In an example, the QoS contract for the second application may be utilized to dynamically select the second ML model to execute the second job within the job request. In certain examples, a determined accuracy target QoS for the second application may be used to select the second ML model. In an example, the second ML model may be a pre-trained ML model, a fine-tuned ML model version, or the like.

At block 312, conflicts between QoS requirements of the first and second jobs are resolved. In an example, a processor may dynamically and continually perform conflict detection and resolution associated with application QoS contracts. For example, the processor may perform conflict detection and resolution when a new job is requested from an application, while two or more ML models are being executed, or the like. During a conflict detection process, a processor may monitor both the QoS contracts and the resource demands associated with different jobs requested by the applications. In an example, the processor may identify or determine when resource demands or accuracy requirements overlap across applications.

In response to conflict detection, the processor may perform one or more operations to resolve the conflict. For example, the processor may perform priority-based resolution, dynamic accuracy adjustment, implement fairness policies, or the like. In certain examples, the processor may perform the conflict resolution by only one of the conflict resolution techniques or may perform any combinations of these conflict resolution techniques.

At block 314, QoS compliance is maintained for the first and second jobs. In certain examples, the processor may perform one or more other operations to maintain QoS compliance of applications. For example, the processor may execute or perform runtime resource management during the execution of applications. During runtime resource management, the processor may continuously monitor the system state of the information handling system and update the configurations of the ML models to maintain QoS compliance of the first and second applications.

At block 316, model selection is updated based on the execution of the current jobs. During execution of the first and second jobs, the processor may perform a real-time feedback loop to continually learn and adapt to changing QoS application contracts on the information handling system. In an example, the processor may perform real-time monitoring of the actual performance of selected ML models against QoS contracts for first and second applications. For example, the actual performance of the ML models may be the observed accuracy, latency, and resource impacts of the ML models when executing the first and second applications. Based on these performance levels, the processor may adapt future model selection decisions for the first and second applications with similar QoS contracts.

At block 318, application-level QoS contracts are updated based on the execution of the current jobs, and the flow ends at block 320. In an example, the processor may continuously refine application-level QoS contracts based on learned personalization of user behavior of the information handling system. Thus, the processor may adapt to user behavior over time, ensuring sustained optimization of user experience while maintaining of ML models accuracy and other QoS contracts.

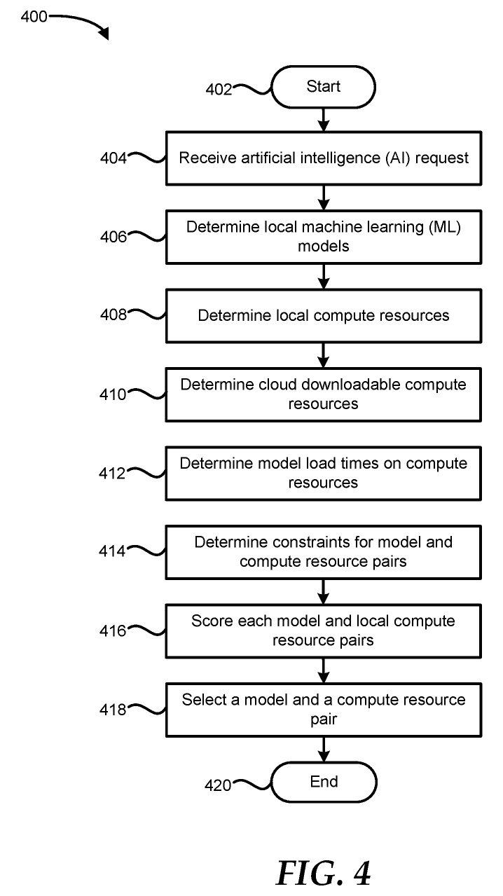

FIG. 4 shows a method 400 for selecting a ML model and corresponding local resource within an information handling system according to at least one embodiment of the present disclosure, starting at block 402. Not every method step set forth in this flow diagram is always necessary, and certain steps of the methods may be combined, performed simultaneously, in a different order, or perhaps omitted, without varying from the scope of the disclosure. FIG. 4 may be employed in whole, or in part, processor 102 of information handling system 100 in FIG. 1, or any other type of controller, device, module, processor, or any combination thereof, operable to employ all, or portions of, the method of FIG. 4.

At block 404, an AI request is received. The AI request may be received at a processor of an information handling system. In an example, the AI request may include, but is not limited to, model input parameters, manual QoS constraints, and automated QoS constraints. At block 406, local ML models are determined. In certain examples, the determined ML models may any suitable models, such as inference models, prediction models, or the like.

At block 408, local compute resources are determined. In certain examples, the local compute resources may include, but are not limited to, a CPU, a GPU, a NPU, an iGPU, a dGPU, an iNPU, and a dNPU. At block 410, cloud downloadable compute resources are determined. In an example, the cloud downloadable compute resource may be a CPU, a GPU, a NPU, an iGPU, a dGPU, an iNPU, a dNPU, or the like.

At block 412, ML model load times on the compute resources are determined. In certain examples, a processor of the information handling system may utilize any suitable data for the ML model to determine ML model load times. For example, the processor may utilize a size of the ML models to determine the load time of the ML model on the different compute resources. At block 414, the constraints for ML model and compute resource pairs are determined. In an example, the QoS constraints include, but are not limited to, user experience (UX), model size, device affinity, request, current system utilization, model utilization, and IT policy.

At block 416, ML models and local compute resources are scored. In certain examples, the processor may calculate a weighted score for each ML model-compute resource pair. The weighted scores may be based on base weights, learned or personalization weights, and dynamic weights for each ML model-compute resource pair. In an example, the base weights may be based at least in part on ITDM policies for the ML model and compute resource pair. The personalization weights may be calculated based on learned patterns from user behavior and preferences. The dynamic weights may be calculated based on the real-time system state metrics of the information handling system.

At block 418, a ML model and compute resource pair is selected, and the flow ends at block 420. In an example, the selected ML model and compute resource pair may be the ML model and compute resource pair with the highest score of the pairs within the information handling system.

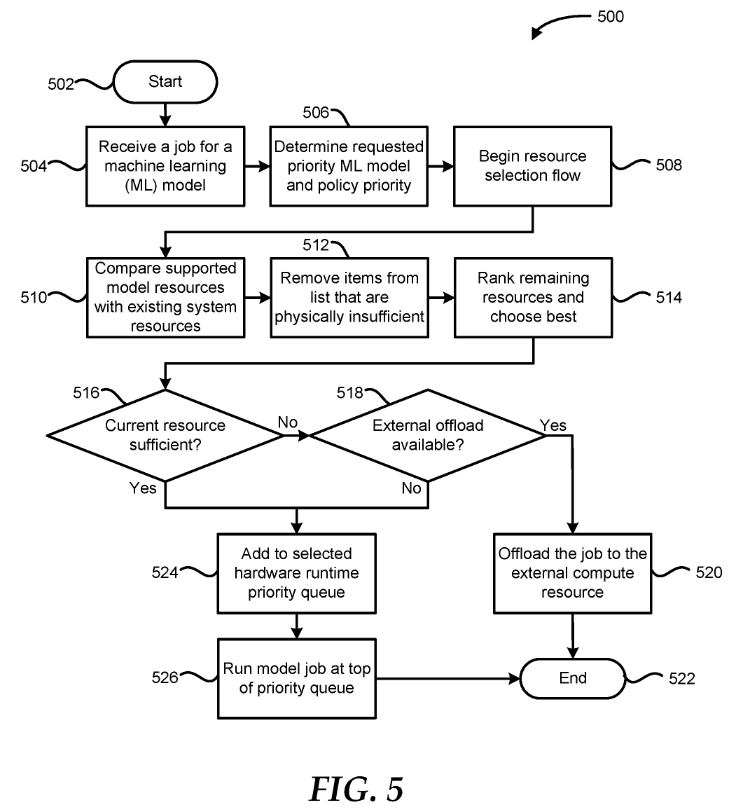

FIG. 5 shows a method 500 for assigning a ML model to local or external resources according to at least one embodiment of the present disclosure, starting at block 502. Not every method step set forth in this flow diagram is always necessary, and certain steps of the methods may be combined, performed simultaneously, in a different order, or perhaps omitted, without varying from the scope of the disclosure. FIG. 5 may be employed in whole, or in part, processor 102 of information handling system 100 in FIG. 1, or any other type of controller, device, module, processor, or any combination thereof, operable to employ all, or portions of, the method of FIG. 5.

At block 504, a job for a ML model is received. In an example, the job may be received from an application being executed or run within an information handling system. The job may include input data to be provided to the ML model. At block 506, requested ML model priority and policy priority are determined. In certain examples, ML priority and policy priority may be determined based on any suitable data associated with the job. For example, these priorities may be determined based on QoS constraints for the application that provided the job and a comparison between these QoS constraints and QoS constraints of other applications being executed within the information handling system.

At block 508, a resource selection flow is begun. In an example, the resource selection flow may be any suitable operations to determine the best compute resource available to execute the ML model to complete the job from the application. At block 510, support ML model resources are compared with existing system compute resources. In certain examples, the compute resources may include, but are not limited to, a CPU, a GPU, a NPU, an iGPU, a dGPU, an iNPU, and a dNPU.

At block 512, items that are physically insufficient are removed from a list of compute resources. In an example, the items may be compute resources of the information handling system. In certain examples, physically insufficient compute resources may include, but are not limited to, those resources that currently have too high of a utilization by other applications. At block 514, remaining ML model and compute resource pairs are ranked and the best pair is selected. In an example, the ML model and compute resource pairs may be rank based on resources loads, existing sessions, policies, local ML model telemetry, compute resource power profile, or the like.

At block 516, a determination is made whether a current compute resource is sufficient. In certain examples, the current compute resource may be compute resource of the selected ML model and compute resource pair. If the current compute resource is sufficient, the flow continues at block 524. Otherwise, if the current compute resource is not sufficient, a determination is made whether an external offload compute resource is available at block 518. In an example, the external offload compute resource may be available in a cloud server or any other remote server associated with the information handling system.

If an external offload compute resource is not available, the flow continues at block 524. If the external compute resource is available, the job is offloaded to the external compute resource at block 520 and the flow ends at block 522. At block 524, the job is added to the selected compute resource priority queue. In an example, the job may be added to the queue based on a priority level of the job and the priority levels any other jobs already in the queue for the compute resource. At block 526, the ML model job at the top of the priority queue is run and the flow ends at block 522. In certain examples, the execution of the top ML model job continues until the compute resource does not have any jobs remaining in the queue.

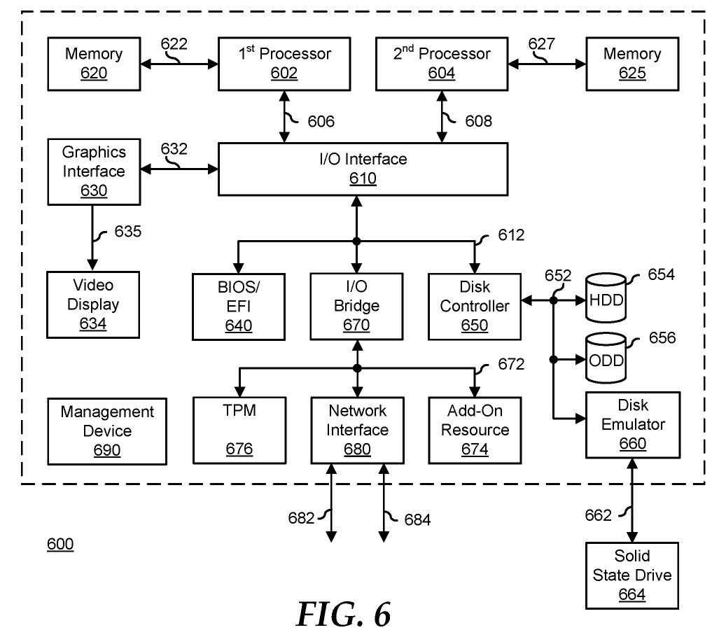

FIG. 6 shows a generalized embodiment of an information handling system 600 according to an embodiment of the present disclosure. Information handling system 600 may be substantially similar to information handling system 100 of FIG. 1. Further, information handling system 600 can include processing resources for executing machine-executable code, such as a central processing unit (CPU), a programmable logic array (PLA), an embedded device such as a System-on-a-Chip (SoC), or other control logic hardware. Information handling system 600 can also include one or more computer-readable medium for storing machine-executable code, such as software or data. Additional components of information handling system 600 can include one or more storage devices that can store machine-executable code, one or more communications ports for communicating with external devices, and various input and output (I/O) devices, such as a keyboard, a mouse, and a video display. Information handling system 600 can also include one or more buses operable to transmit information between the various hardware components.

Information handling system 600 can include devices or modules that embody one or more of the devices or modules described below and operates to perform one or more of the methods described below. Information handling system 600 includes a processors 602 and 604, an input/output (I/O) interface 610, memories 620 and 625, a graphics interface 630, a basic input and output system/universal extensible firmware interface (BIOS/UEFI) module 640, a disk controller 650, a hard disk drive (HDD) 654, an optical disk drive (ODD) 656 , a disk emulator 660 connected to an external solid state drive (SSD) 664, an I/O bridge 670, one or more add-on resources 674, a trusted platform module (TPM) 676, a network interface 680, a management device 690, and a power supply 695. Processors 602 and 604, I/O interface 610, memory 620, graphics interface 630, BIOS/UEFI module 640, disk controller 650, HDD 654, ODD 656, disk emulator 660, SSD 664, I/O bridge 670, add-on resources 674, TPM 676, and network interface 680 operate together to provide a host environment of information handling system 600 that operates to provide the data processing functionality of the information handling system. The host environment operates to execute machine-executable code, including platform BIOS/UEFI code, device firmware, operating system code, applications, programs, and the like, to perform the data processing tasks associated with information handling system 600.

In the host environment, processor 602 is connected to I/O interface 610 via processor interface 606, and processor 604 is connected to the I/O interface via processor interface 608. Memory 620 is connected to processor 602 via a memory interface 622. Memory 625 is connected to processor 604 via a memory interface 627. Graphics interface 630 is connected to I/O interface 610 via a graphics interface 632 and provides a video display output 636 to a video display 634. In a particular embodiment, information handling system 600 includes separate memories that are dedicated to each of processors 602 and 604 via separate memory interfaces. An example of memories 620 and 630 include random access memory (RAM) such as static RAM (SRAM), dynamic RAM (DRAM), non-volatile RAM (NV-RAM), or the like, read only memory (ROM), another type of memory, or a combination thereof.

BIOS/UEFI module 640, disk controller 650, and I/O bridge 670 are connected to I/O interface 610 via an I/O channel 612. An example of I/O channel 612 includes a Peripheral Component Interconnect (PCI) interface, a PCI-Extended (PCI-X) interface, a high-speed PCI-Express (PCIe) interface, another industry standard or proprietary communication interface, or a combination thereof. I/O interface 610 can also include one or more other I/O interfaces, including an Industry Standard Architecture (ISA) interface, a Small Computer Serial Interface (SCSI) interface, an Inter-Integrated Circuit (I²C) interface, a System Packet Interface (SPI), a Universal Serial Bus (USB), another interface, or a combination thereof. BIOS/UEFI module 640 includes BIOS/UEFI code operable to detect resources within information handling system 600, to provide drivers for the resources, initialize the resources, and access the resources. BIOS/UEFI module 640 includes code that operates to detect resources within information handling system 600, to provide drivers for the resources, to initialize the resources, and to access the resources.

Disk controller 650 includes a disk interface 652 that connects the disk controller to HDD 654, to ODD 656, and to disk emulator 660. An example of disk interface 652 includes an Integrated Drive Electronics (IDE) interface, an Advanced Technology Attachment (ATA) such as a parallel ATA (PATA) interface or a serial ATA (SATA) interface, a SCSI interface, a USB interface, a proprietary interface, or a combination thereof. Disk emulator 660 permits SSD 664 to be connected to information handling system 600 via an external interface 662. An example of external interface 662 includes a USB interface, an IEEE 4394 (Firewire) interface, a proprietary interface, or a combination thereof. Alternatively, solid-state drive 664 can be disposed within information handling system 600.

I/O bridge 670 includes a peripheral interface 672 that connects the I/O bridge to add-on resource 674, to TPM 676, and to network interface 680. Peripheral interface 672 can be the same type of interface as I/O channel 612 or can be a different type of interface. As such, I/O bridge 670 extends the capacity of I/O channel 612 when peripheral interface 672 and the I/O channel are of the same type, and the I/O bridge translates information from a format suitable to the I/O channel to a format suitable to the peripheral channel 672 when they are of a different type. Add-on resource 674 can include a data storage system, an additional graphics interface, a network interface card (NIC), a sound/video processing card, another add-on resource, or a combination thereof. Add-on resource 674 can be on a main circuit board, on separate circuit board or add-in card disposed within information handling system 600, a device that is external to the information handling system, or a combination thereof.

Network interface 680 represents a NIC disposed within information handling system 600, on a main circuit board of the information handling system, integrated onto another component such as I/O interface 610, in another suitable location, or a combination thereof. Network interface device 680 includes network channels 682 and 684 that provide interfaces to devices that are external to information handling system 600. In a particular embodiment, network channels 682 and 684 are of a different type than peripheral channel 672 and network interface 680 translates information from a format suitable to the peripheral channel to a format suitable to external devices. An example of network channels 682 and 684 includes InfiniBand channels, Fibre Channel channels, Gigabit Ethernet channels, proprietary channel architectures, or a combination thereof. Network channels 682 and 684 can be connected to external network resources (not illustrated). The network resource can include another information handling system, a data storage system, another network, a grid management system, another suitable resource, or a combination thereof.

Management device 690 represents one or more processing devices, such as a dedicated baseboard management controller (BMC) System-on-a-Chip (SoC) device, one or more associated memory devices, one or more network interface devices, a complex programmable logic device (CPLD), and the like, which operate together to provide the management environment for information handling system 600. In particular, management device 690 is connected to various components of the host environment via various internal communication interfaces, such as a Low Pin Count (LPC) interface, an Inter-Integrated-Circuit (I2C) interface, a PCIe interface, or the like, to provide an out-of-band (OOB) mechanism to retrieve information related to the operation of the host environment, to provide BIOS/UEFI or system firmware updates, to manage non-processing components of information handling system 600, such as system cooling fans and power supplies. Management device 690 can include a network connection to an external management system, and the management device can communicate with the management system to report status information for information handling system 600, to receive BIOS/UEFI or system firmware updates, or to perform other task for managing and controlling the operation of information handling system 600.

Management device 690 can operate off of a separate power plane from the components of the host environment so that the management device receives power to manage information handling system 600 when the information handling system is otherwise shut down. An example of management device 690 include a commercially available BMC product or other device that operates in accordance with an Intelligent Platform Management Initiative (IPMI) specification, a Web Services Management (WSMan) interface, a Redfish Application Programming Interface (API), another Distributed Management Task Force (DMTF), or other management standard, and can include an Integrated Dell Remote Access Controller (iDRAC), an Embedded Controller (EC), or the like. Management device 690 may further include associated memory devices, logic devices, security devices, or the like, as needed, or desired.

Although only a few exemplary embodiments have been described in detail herein, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

What is claimed is:

1. An information handling system comprising:
a memory to store a plurality of machine learning (ML) models; and
a processor to communicate with the memory, the processor to:
receive a job request including input parameters and constraints for a job associated with the job request;
based on the input parameters and the constraints, identify first and second ML models available to execute the job;
generate a first score for the first ML model and a second score for the second ML model; and
based on the first score being greater than the second score, provide the job to a compute resource associated with the first ML model.

2. The information handling system of claim 1, wherein the processor further to: determine a first model and resource pair associated the first ML model with a first compute resource of the information handling system.

3. The information handling system of claim 2, wherein the first score is based on constraints of the first compute resource.

4. The information handling system of claim 1, wherein the memory further to: store a plurality of model and resource pairs of the information handling system.

5. The information handling system of claim 4, wherein the processor further to:
determine patterns of user behavior and preferences; and
based on the patterns of user behavior and preferences, store personalization weights for each of the model and resource pairs in the memory.

6. The information handling system of claim 1, wherein the first score is based on a plurality of weights for system prioritization of the first ML model.

7. The information handling system of claim 1, wherein the constraints include user contraints and system constraints.

8. A method comprising:
storing, in an information handling system, a plurality of machine learning (ML) models;
receiving, by the information handling system, a job request including input parameters and constraints for a job associated with the job request;
based on the input parameters and the constraints, identifying first and second ML models available to execute the job;
generating a first score for the first ML model and a second score for the second ML model; and
based on the first score being greater than the second score, providing the job to a compute resource associated with the first ML model.

9. The method of claim 8, further comprising determining a first model and resource pair associated the first ML model with a first compute resource of the information handling system.

10. The method of claim 9, wherein the first score is based on constraints of the first compute resource.

11. The method of claim 8, further comprising storing, in the memory, a plurality of model and resource pairs of the information handling system.

12. The method of claim 11, further comprising:
determining patterns for user behavior and preferences; and
based on the user behavior and preferences, storing personalization weights for each of the model and resource pairs in the memory.

13. The method of claim 8, wherein the first score is based on a plurality of weights for system prioritization of the first ML model.

14. The method of claim 8, wherein the constraints include user contraints and system constraints.

15. A method comprising:
receiving, by an information handling system, a first job request from a first application, wherein the first job request includes first quality of service (QoS) requirements for a first job of the first application;
determining a first machine learning (ML) model to execute the first job;
receiving, by the system, a second job request from a second application, wherein the second job request includes second QoS requirements for a second job of the second application;
determining a second ML model to execute the second job;
determining a conflict between the first QoS requirements and the second QoS requirements; and
based on the conflict, allocate resources between the first ML model and the second ML model based on priority levels of the first and second applications.

16. The method of claim 15, further comprising reducing accuracy requirements for the second ML model based on the first application having a higher QoS priority level as compared to the second application.

17. The method of claim 15, wherein the conflict between the first QoS requirements and the second QoS requirements is based on accuracy requirements overlaping between the first application and the second application.

18. The method of claim 15, further comprising:
monitoring a performance of the first ML model compared to the first QoS requirements; and
updating ML selection process based on the performance of the first ML model compared to the first QoS requirements.

19. The method of claim 15, further comprising:
monitoring a current system state of resources within the information handling system; and
based on the current system state of the resources, changing runtime configurations to maintain QoS compliance for the first application and the second application.

20. The method of claim 15, further comprising:
determining user behavior for the information handling system; and
based on the user behavior, updating application level QoS contracts.
